(19) United States
(12) Patent Application Publication
(10) Pub. No.: US 2014/0374079 A1
(43) Pub. Date: Dec. 25, 2014

(54) CONFORMABLE AND ADHESIVE SOLID COMPOSITIONS FORMED FROM METAL NANOPARTICLES AND METHODS FOR THEIR PRODUCTION AND USE

(71) Applicant: LOCKHEED MARTIN CORPORATION, Bethesda, MD (US)

(72) Inventors: Alfred A. ZINN, Palo Alto, CA (US); Jerome Chang, San Jose, CA (US); Randall Mark Stoltenberg, Palo Alto, CA (US)

(21) Appl. No.: 14/306,085

(22) Filed: Jun. 16, 2014

Related U.S. Application Data
(60) Provisional application No. 61/838,147, filed on Jun. 21, 2013.

(51) Int. Cl. C09K 5/14; C09J 11/04; F28F 21/00

(52) U.S. Cl. CPC C09K 5/14; F28F 21/00; C09J 11/04; C09J 2400/16
USPC 165/185; 252/75

(57) ABSTRACT

Materials that readily adhere to and conform to various surfaces can be desirable for a number of applications. In heat transfer and thermal management applications, for example, conformable materials can be used in establishing a thermal interface between a heat source and a heat sink. There are limited materials that provide good thermal conductivity values while maintaining capabilities to readily adhere and conform to a surface. Compositions including a conformable and adhesive solid can include a reaction product formed by heating a mixture containing a plurality of metal nanoparticles, one or more amines, and one or more carboxylic acids. The compositions can further include one or more additives dispersed in the conformable and adhesive solid.

### CROSS-REFERENCE TO RELATED APPLICATIONS

This application claims the benefit of priority under 35 U.S.C. §119 from U.S. Provisional Patent Application 61/838,147, filed Jun. 21, 2013, which is incorporated herein by reference in its entirety.

### STATEMENT REGARDING FEDERALLY SPONSORED RESEARCH OR DEVELOPMENT

Not applicable.

### FIELD

The present disclosure generally relates to nanomaterials, and, more specifically, to conformable and adhesive solid compositions formed from nanomaterials, methods for their production, and use thereof in thermal management applications.

### BACKGROUND

Ineffective thermal communication between a heat source and a heat sink can often hamper the dissipation of excess heat from a system, particularly when the heat source and the heat sink are non-contiguous and only abut one another. Thermal interface materials (TIMs) can be used in many instances to form a thermal connection between an abutted heat source and heat sink to promote better heat transfer between the two through minimizing contact voids that convey heat poorly, as well as sometimes providing at least some degree of mechanical coupling between the heat source and heat sink. Dissipation of excess heat through the heat sink can help protect various system components from overheating. In electronics applications, for example, TIMs can be used to promote the transfer of excess heat from a microprocessor to any number of heat-dissipation devices. Heat transfer and dissipation processes can be even more problematic in extreme applications, where there can be issues of shock and vibration, for example, that can disrupt thermal communication between a heat source and a heat sink.

Thermal greases, thermal epoxies, and other polymer-containing materials are commonly used for forming thermal interfaces between various structures. These substances often contain bulk filler particles such as silver, copper, diamond, and/or graphite to enhance their thermal conductivity values. One commonly used example of such a thermal interface material is ARCTIC SILVER 5. Even with enhancement of their thermal conductivity values, conventional thermal interface materials still display relatively low thermal conductivity values (˜1-7 W/m·K), primarily due to their polymer content (high thermal impedance) and limited filler particle connectivity, which can limit their ability to transfer heat and establish an effective thermal interface. In comparison, metals have thermal conductivity values of hundreds of W/m·K (e.g., −400 W/m·K for copper metal). In addition, many conventionally used TIMs are expensive, require long curing cycles and undergo outgassing, involve difficult and messy application techniques, provide limited rework capabilities, and convey limited vibration and shock absorption protection. The fairly large grain size of the filler particles also dictates the minimum achievable thickness of the thermal interface, thereby limiting the ultimately achievable heat transfer rates. Thus, conventional thermal interface materials can be limited in high performance applications such as space, military and commercial applications.

In view of the foregoing, the development of inexpensive thermal interface materials that are simple to use while maintaining good thermal conductivity performance would be of substantial benefit in the art. The present disclosure satisfies the foregoing need and provides related advantages as well.

### SUMMARY

In various embodiments, the present disclosure describes compositions containing a conformable and adhesive solid that can maintain those properties when thermally conductive additives are included therein, thereby promoting good thermal conductivity. In some embodiments, the compositions containing the conformable and adhesive solid can include a reaction product formed by healing a mixture combining a plurality of metal nanoparticles, one or more amines, and one or more-carboxylic acids.

In various embodiments, methods for forming a conformable and adhesive solid can include providing a mixture containing a plurality of metal nanoparticles, one or more amines, and one or more carboxylic acids, and heating the mixture to form a conformable and adhesive solid as a reaction product.

In other various embodiments, thermal interfaces containing a conformable and adhesive solid formed from a nanomaterial are described herein. In some embodiments, the thermal interfaces can include a first surface constituting a heat source, a second surface constituting a heat sink, and a thermal interface material in contact with the first surface and the second surface and establishing a thermal connection therebetween. The thermal interface material includes a conformable and adhesive solid containing a reaction product formed by heating a mixture including a plurality of metal nanoparticles, one or more amines, and one or more carboxylic acids. The metal nanoparticles include at least copper nanoparticles. The thermal interface material also includes one or more additives dispersed in the conformable and adhesive solid, where the one or more additives include bulk metal powders, bulk metal flakes, graphite particles, graphene particles, carbon black particles, amorphous carbon particles, aluminum oxide particles, beryllium oxide panicles, magnesium oxide particles, diamond particles, a fibrous material, a metal solder, a polymer, and any combination thereof.

The foregoing has outlined rather broadly the features of the present disclosure in order that the detailed description that follows can be better understood. Additional features and advantages of the disclosure will be described hereinafter. These and other advantages and features will become more apparent from the following description.

### BRIEF DESCRIPTION OF THE DRAWINGS

For a more complete understanding of the present disclosure, and the advantages thereof reference is now made to the following descriptions to be taken in conjunction with the accompanying drawings describing specific embodiments of the disclosure, wherein:

FIG. 1 shows the presumed structure of an illustrative metal nanoparticle having a surfactant coating thereon;

FIG. 2 shows an illustrative FTIR spectrum of the reaction product obtained upon heating copper nanoparticles, carboxylic acids and amines;

FIGS. 3A and 3B show illustrative comparative SEM images of the copper nanoparticles and the reaction product, respectively;

FIG. 4 shows an illustrative plot of the copper nanoparticle size distribution before and after forming the reaction product;

FIG. 5 shows an illustrative TGA plot comparing the composition of Example 1 with the composition of Example 3;

FIGS. 6A and 6B show illustrative SEM images of the reaction product of Example 3 before and after compacting, respectively; and

FIGS. 7 and 8 show increased magnification SEM images of the reaction product of Example 3.

### DETAILED DESCRIPTION

The present disclosure is directed, in part, to conformable and adhesive compositions formed from metal nanoparticles. The present disclosure is also directed, in part, to methods for making conformable and adhesive compositions from metal nanoparticles. The present disclosure is also directed, in part, to methods for using such conformable and adhesive compositions in thermal management applications, particularly as a thermal interface material. The present disclosure is also directed, in part, to thermal interfaces formed with such conformable and adhesive compositions.

As discussed above, ineffective heat transfer between non-contiguous surfaces can be problematic in a number of instances. A large number of heat transfer issues are believed to arise from insufficient heat transfer through a thermal interface material. Although thermal greases and thermal epoxies containing thermal conductivity enhancers can sometimes be effective to promote better heat transfer, these materials are performance limited and present various issues in their use. Certainly, there has been little progress made in making the thermal conductivity values of conventional thermal interface materials even approach those displayed by bulk metals. It is believed that this lack of progress is primarily due to the inability to significantly increase the quantities of thermal conductivity enhancers in the thermal interface materials and establish thermal connections therebetween, at least without sacrificing surface conformance, compliance and adherence. As used herein, the term “conformance” and grammatical variants thereof will refer to the tendency of a composition to deform to match the contours of a surface with a minimum of void formation. As used herein, the term “adherence” and grammatical variants thereof will refer to the tendency of a composition to remain bound to surface, without reference to the bonding mechanism. As used herein, the term “compliance” and grammatical variants thereof will refer to the deformation and rebound of a substance following the application and release of a compressive force.

Although metal nanoparticle compositions can be used in low temperature soldering applications to form a metal joint between two surfaces through fusing the metal nanoparticles together, thereby creating a highly thermally conductive network of bulk metal, such metal joints do not usually promote effective vibration dampening and shock absorption, and surface adherence can sometimes be an issue. Moreover, forming a metal joint between two surfaces by fusing metal nanoparticles together effectively forms a “permanent” metal connection between the two surfaces with limited rework capabilities, whereas a weaker connection can often be desirable. Weaker connectivity represents a desirable property of existing thermal greases but not thermal epoxies. Thermal epoxies, in contrast, are rigid and relatively permanent. Further, although if can be desirable in some instances, a metal joint formed directly from metal nanoparticles generally offers no opportunity for electrical isolation between the heat source and the heat sink due to high electrical conductivity of the bulk metal network.

The present inventors discovered that compositions formed from metal nanoparticles in the presence of an organic matrix can be used very effectively in forming thermal interfaces. As discussed hereinafter, these compositions allow high thermal conductivity values to be realized when thermally conductive additives are included, similar to those obtained from bulk metals, while providing a “non-permanent” connection between surfaces, comparable to that offered by existing thermal greases. In contrast to existing thermal greases, the compositions described herein are much more easily handled and provide other advantages as well. Accordingly, the compositions described herein combine the desirable aspects of existing thermal greases with those of high thermal conductivity materials.

More particularly, the present inventors discovered that metal nanoparticles can facilitate the formation of a very viscous solid reaction product in the presence of one or more amines and one or more carboxylic acids. The reaction product is readily conformable, compliant, and adheres to a wide variety of surfaces, including polytetrafluoroethylene surfaces. Moreover, these properties are maintained once thermally conductive fillers have been added and the thermal conductivity has been enhanced, as discussed below. Before introducing the thermally conductive fillers, the thermal conductivity of the reaction product is typically low, about 1-2 W/m·K, indicating limited connectivity between the metal nanoparticles. The reaction product can be simply formed by controlled heating of a mixture of the metal nanoparticles, one or more amines and one or more carboxylic acids, optionally in the presence of one or more organic solvents. Before heating to form the reaction product, the mixture is not readily adherent to most surfaces. After the heating process, however, the reaction product can be spread on or applied to most any surface and provide a tacky, potentially thermally conductive interface between various surfaces, much like existing thermal greases but without the workability issues associated with these substances.

Although the reaction products themselves generally have fairly low thermal conductivity values, their thermal conductivity can be significantly enhanced while maintaining their desirable properties. Specifically, thermal conductivity enhancers such as bulk metal particles or bulk metal flakes, as well as non-metallic particles and fibers having good thermal conductivity values can be dispersed in the reaction product to form a thermally conductive composition. Such thermal conductivity enhancers can be introduced to the compositions either after or in concert with their formation, the latter provided that the thermal conductivity enhancers do not interfere with formation of the reaction product. Because of the tacky nature of the reaction product formed from the one or more amines and the one or more carboxylic acids, a high loading of the thermal conductivity enhancers can be included in the compositions without compromising their conformability and adherence. This feature represents a particular advantage over existing thermal greases, where the opportunity to increase the loading of thermal conductivity enhancers is limited.

Similar to the thermal conductivity enhancers described above, polymers can also be included in the compositions described herein. Inclusion of a polymer in the compositions can be desirable when one wants to decrease the composition's, electrical conductivity, while maintaining good thermal conductivity values. Inclusion of a polymer in the compositions can also make the compositions more workable and conformable in some embodiments.

Without being bound by any theory or mechanism, it is believed that the metal nanoparticles can promote a polymerization reaction or an oligomerization reaction between the one or more amines and the one or more carboxylic acids to form the conformable and adhesive solid of the compositions described herein. All three components are believed to be necessary to form the conformable and adhesive solid, since omitting the metal nanoparticles from the mixture during the heating process failed to produce a conformable and adhesive solid with the amines and carboxylic acids alone. The reaction product is believed to differ from polymers and oligomers formed during conventional processes that form polyamides, although at least some degree of polymerization or oligomerization to a polyamide product may occur. Continuing to be unbound by theory or mechanism, it is believed that the metal nanoparticles both catalyze the formation of the reaction product, likely through the formation of amide groups, and serve as crosslinking junctions between adjacent polymer/oligomer chains (e.g., between amide groups). An organic surfactant coating on the metal nanoparticles may also play a role in the formation of the reaction product. It is also believed that at least a portion of the metal nanoparticles maintain their nanoparticulate structure in the reaction product, rather than all of the metal nanoparticles fusing together to form a bulk metal structure. Some smaller metal nanoparticles may coalesce into larger metal nanoparticles during the heating process. Remaining unbound by theory or mechanism. It is believed that the reaction product, as it forms, can protect the metal nanoparticles from fusing together with one another, thereby leaving the metal nanoparticles isolated from one another and dispersed in the matrix of the reaction product.

As used herein, the term “metal nanoparticle” will refer to non-fibrous metal particles that are about 100 nm or less in size, without particular reference to the shape of the metal particles. As used herein, the term “bulk metal” will refer to non-fibrous metal particles that are larger than about 100 nm in size, particularly about 1 micron or larger in size. As used herein, the term “fibrous” will refer to a substance having an aspect ratio of about 10:1 or more. As used herein, the term “flake” will refer to a non-fibrous particle that has a thickness less than its width.

In various embodiments, compositions described herein can include a conformable and adhesive solid containing a reaction product formed by heating a mixture containing a plurality of metal nanoparticles, optionally one or more organic solvents, one or more amines, and one or more carboxylic acids. In various embodiments, the compositions can have an adhesive strength of at least about 37 psi cohesive failure, with no interface failure observed, between polytetrafluoroethylene, copper, nickel and aluminum surfaces.

In some embodiments, the metal nanoparticles can include at least copper nanoparticles. Copper nanoparticles can be desirable for use in thermal interface applications due to copper's high thermal conductivity value and relatively low cost. Other suitable metal nanoparticles that can be present in the compositions, either individually or in combination with copper nanoparticles include, but are not limited to, nickel nanoparticles, aluminum nanoparticles, tin nanoparticles, silver nanoparticles, palladium nanoparticles, iron nanoparticles, cobalt, nanoparticles, titanium nanoparticles, zirconium nanoparticles, hafnium nanoparticles, tantalum nanoparticles, gold nanoparticles, the like and any combination thereof. In other various embodiments, nickel, aluminum, tin, silver, palladium, iron, cobalt, titanium, zirconium, hafnium, tantalum, gold, the like or any combination thereof can be used to form a shell upon copper nanoparticles used in various configurations of the present disclosure. Other metal nanoparticles or core-shell variants thereof can also be suitable for use in the embodiments described herein.

The mixture from which the conformable and adhesive solid is formed can vary over a fairly wide compositional range. In various embodiments, the mixture can contain an organic solvent and include, in total, between about 10% to about 28% by weight of organic solvents, amines plus carboxylic acids. In more particular embodiments, the mixture can contain an organic solvent and include, in total, between about 16% to about 20% by weight of organic solvents, amines plus carboxylic acids. When forming the reaction product through healing the mixture, at least a portion of the organic solvent evaporates, and the conformable and adhesive solid contains a low level of volatiles (<5% by weight). In some embodiments, the mixture can include substantially equal amounts by weight of the one or more amines and the one or more carboxylic acids. In other various embodiments, different quantities of the one or more amines and the one or more carboxylic acids can be present. Generally, the quantities of the one or more amines and the one or more carboxylic acids are within about 25% of each other on a molar basis.

The carboxylic acids used in forming the compositions described herein are not believed to be particularly limited in structure. In various embodiments, the carboxylic acids can be monocarboxylic acids or dicarboxylic acids and can contain between 1 and about 18 carbon atoms. Illustrative examples of carboxylic acids that can be used in forming the conformable and adhesive solid of the compositions described herein can include, for example, hexanoic acid, octanoic acid, decanoic acid, dodecanoic acid, hexadecanoic acid, octadecanoic acid, oxalic acid, malonic acid, succinic acid, benzoic acid, any combination thereof, and the like. The carboxylic acids can be straight chained, branched, or any combination thereof. In some embodiments, anhydrides can be used equivalently as a precursor to the one or more carboxylic acids.

The amines used in forming the compositions described herein are similarly not believed to be particularly limited in structure, as long as at least one active hydrogen is present. In various embodiments, the amines can be primary amines, particularly primary aliphatic amines and secondary aliphatic amines, and they can contain one or more amine nitrogen atoms. Illustrative examples of amines that can be used in forming the conformable and adhesive solid of the compositions described herein can include, for example, n-hexylamine, n-octylamine, n-dodecylamine, n-hexadecylamine, n-octadecylamine, ethylenediamine, propylenediamine, 1,6-hexanediamine, diethylenetriamine, triethylenetetramine, any combination thereof, and the like. Generally, any amine that can be used in conjunction with forming metal nanoparticles as a surfactant (see below) can also be used in forming the reaction product constituting the conformable and adhesive solids described herein. The amines can be straight chained, branched, or any combination thereof.

In various embodiments, the metal nanoparticles can constitute the balance of the mixture from which the conformable and adhesive solid is formed. Accordingly, in some embodiments, the mixture from which the conformable solid is formed can include about 72% to about 90% by weight metal nanoparticles, and about 10% to about 28% by weight of organic solvents, amines plus carboxylic acids. It should be noted that these values do not necessarily represent the final amounts of the various components in the conformable and adhesive solid after if is formed. As described hereinafter, in forming the reaction product, the organic solvent is generally at least partially evaporated, leaving a low level of volatile material in the reaction product.

Inclusion of an organic solvent in the mixture during formation of the reaction product can aid in dispersing the metal nanoparticles, amines and carboxylic acids together with one another during their reaction. However, the reaction product can still be formed without the organic solvent being present by heating the metal nanoparticles, one or more amines, and one or more carboxylic acids neat with one another. When present, the organic solvent in the mixture substantially evaporates in the course of forming the reaction product. In some embodiments, suitable organic solvents can include those commonly used in the formation of metal nanoparticles, such as those described hereinbelow. Many of the organic solvents used in the formation of metal nanoparticles are fairly high boiling and are not readily evaporable as a result. Lower boiling organic solvents such as, for example, hexane, toluene, acetone, methyl ethyl ketone, dichloromethane, tetrahydrofuran, ethyl ether, methanol, ethanol, isopropanol and the like can be more desirable for inclusion in the mixture in some embodiments of the present disclosure due to their high volatility. Mixtures of these solvents can also be used. In some embodiments, an alcohol solvent or a mixture of alcohol solvents may be used. An amount of the organic solvent can be up to about 40% by weight of the amine/carboxylic acid mixture being used to form the reaction product. In more particular embodiments, the amount of the organic solvent can range between about 2% to about 10% by weight of the amine/carboxylic acid mixture, including those cases where conductive fillers are present.

In addition to promoting the formation of the conformable and adhesive solids described herein, metal nanoparticles can exhibit a number of properties that differ significantly from those of the corresponding bulk metal. One property of metal nanoparticles that can be of particular importance is nanoparticle liquefication that occurs at the metal nanoparticles' fusion temperature, which can be significantly below the melting point of the corresponding bulk metal if the nanoparticles are of a small enough size, particularly below about 20 nm in equivalent spherical diameter. For example, copper nanoparticles having a size of about 20 nm or less can have a fusion temperature of about 220° C. or below, in comparison to bulk copper's melting point of 1083° C. As used herein, the term “fusion temperature” will refer to the temperature at which a metal nanoparticle liquefies, thereby giving the appearance of melting. As used herein, the terms “fusion,” “fuse” and other grammatical variants thereof will refer to the coalescence or partial coalescence of metal nanoparticles with one another following nanoparticle liquefication. These terms can also refer to the coalescence or partial coalescence of metal nanoparticles with larger particulate materials, such as bulk metal particles, whereby the liquefied metal nanoparticles function as a “glue” that binds the larger particulate materials to one another but without melting the larger particulate materials.

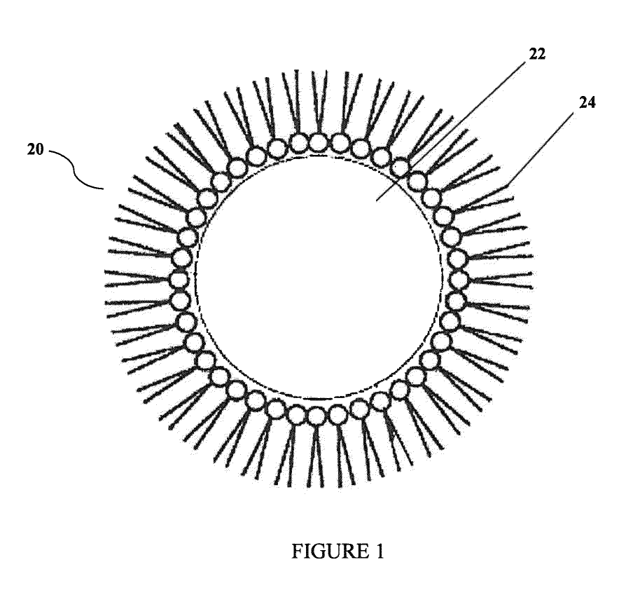

Particularly facile metal nanoparticle fabrication techniques are described in commonly owned U.S. Pat. Nos. 7,736,414, 8,105,414, 8,192,866, and 8,486,305; commonly owned United States Patent Application Publications 2012/0114521 and 2011/0215279; and commonly owned U.S. patent application Ser. No. 13/656,590, filed on Oct. 19, 2012, each of which is incorporated herein by reference in its entirety. As described therein, metal nanoparticles can be fabricated in a narrow size range by reduction of a metal salt in a solvent in the presence of a suitable surfactant system. Further description of suitable surfactant systems follows below. In the presence of a suitable surfactant system, metal nanoparticles having a size range between about 1 nm and about 50 nm and including a surfactant coating thereon can be produced. In more particular embodiments, metal nanoparticles having a surfactant coating and a size range between about 1 nm and about 20 nm, or between about 1 nm and about 10 nm, or between about 1 nm and about 7 nm, or between about 1 nm and about 5 nm can be produced. Without being bound by any theory or mechanism, FIG. 1 shows the presumed structure of an illustrative metal nanoparticle having a surfactant coating thereon. As shown in FIG. 1, metal nanoparticle 20 includes metal sphere 22 and surfactant coating 24 disposed thereon. Remaining unbound by any theory or mechanism, it is believed that the surfactant system can mediate the nucleation and growth of the metal nanoparticles, limit surface oxidation of the metal nanoparticles, and/or inhibit metal nanoparticles from extensively aggregating with one another prior to nanoparticle fusion.

Suitable organic solvents for solubilizing metal salts and forming metal nanoparticles can include aprotic solvents such as, for example, formamide, N,N-dimethylformamide, dimethyl sulfoxide, dimethylpropylene urea, hexamethylphosphoramide, tetrahydrofuran, glyme, diglyme, triglyme, tetraglyme and the like. Reducing agents suitable for reducing metal salts and promoting the formation of metal nanoparticles can include, for example, an alkali metal in the presence of a suitable catalyst (e.g., lithium naphthalide, sodium naphthalide, or potassium naphthalide) or borohydride reducing agents (e.g., sodium borohydride, lithium borohydride, potassium borohydride, or a tetraalkylammonium borohydride).

In various embodiments, the surfactant system used to prepare the metal nanoparticles can include one or more surfactants. The differing properties of various surfactants can be used to tailor the properties of the metal nanoparticles, such as their size. Factors that can be taken into account when selecting a surfactant or combination of surfactants for use in synthesizing metal nanoparticles can include, for example, ease of surfactant dissipation from the metal nanoparticles during nanoparticle fusion, nucleation and growth rates of the metal nanoparticles, affinity of the surfactants with the chosen metal, and the like.

In some embodiments, an amine surfactant or combination of amine surfactants, particularly aliphatic amines, can be used during the synthesis of metal nanoparticles. In some embodiments, two amine surfactants can be used in combination with one another. In other embodiments, three amine surfactants can be used in combination with one another. In more specific embodiments, a primary amine, a secondary amine, and a diamine chelating agent can be used in combination with one another. In still more specific embodiments, the three amine surfactants can include a long chain primary amine, a secondary amine, and a diamine having at least one tertiary alkyl group nitrogen substituent. Further disclosure regarding suitable amine surfactants follows hereinafter.

In some embodiments, the surfactant system can include a primary alkylamine. In some embodiments, the primary alkylamine can be a C₂-C₁₈ alkylamine. In some embodiments, the primary alkylamine can be a C₇-C₁₀ alkylamine. In other embodiments, a C₅-C₆ primary alkylamine can also be used. Without being bound by any theory or mechanism, the exact size of the primary alkylamine can be balanced between being long enough to provide an effective inverse micelle structure versus having ready volatility and/or ease of handling. For example, primary alkylamines with more than 18 carbons can also be suitable for use in the present embodiments, but they can be more difficult to handle because of their waxy character. C₇-C₁₀ primary alkylamines, in particular, can represent a good balance of desired properties for ease of use.

In some embodiments, the C₂-C₁₈ primary alkylamine can be n-heptylamine, n-octylamine, n-nonylamine, or n-decylamine, for example. While these are all straight chain primary alkylamines, branched chain primary alkylamines can also be used in other embodiments. For example, branched chain primary alkylamines such as, for example, 7-methyloctylamine, 2-methyloctylamine, or 7-methylnonylamine can be used in some embodiments. In some embodiments, such branched chain primary alkylamines can be sterically hindered where they are attached to the amine nitrogen atom. Non-limiting examples of such sterically hindered primary alkylamines can include, for example, t-octylamine, 2-methylpentan-2-amine, 2-methylhexan-2-amine, 2-methylheptan-2-amine, 3-ethyloctan-3-amine, 3-ethylheptan-3-amine, 3-ethylhexan-3-amine, and the like. Additional branching can also be present. Without being bound by any theory or mechanism, it is believed that primary alkylamines can serve as ligands in the metal coordination sphere but can be readily dissociable during metal nanoparticle fusion.

In some embodiments, the surfactant system can include a secondary amine. Secondary amines suitable for forming metal nanoparticles can include normal branched, or cyclic C₄-C₁₂ alkyl groups bound to the amine nitrogen atom. In some embodiments, the branching can occur on a carbon atom bound to the amine nitrogen atom, thereby producing significant steric encumbrance at the nitrogen atom. Suitable secondary amines can include, without limitation, dihexylamine, diisobutylamine, di-t-butylamine, dineopentylamine, di-t-pentylamine, dicyclopentylamine, dicyclohexylamine, and the like. Secondary amines outside the C₄-C₁₂ range can also be used, but such secondary amines can have undesirable physical properties such as low boiling points or waxy consistencies that can complicate their handling.

In some embodiments, the surfactant system can include a chelating agent, particularly a diamine chelating agent. In some embodiments, one or both of the nitrogen atoms of the diamine chelating agent can be substituted with one or two alkyl groups. When two alkyl groups are present on the same nitrogen atom, they can be the same or different. Further, when both nitrogen atoms are substituted, the same or different alkyl groups can be present. In some embodiments, the alkyl groups can be C₁-C₆ alkyl groups. In other embodiments, the alkyl groups can be C₁-C₄ alkyl groups or C₃-C₆ alkyl groups. In some embodiments, C₃ or higher alkyl groups can be straight or have branched chains. In some embodiments, C₃ or higher alkyl groups can be cyclic. Without being bound by theory or mechanism. It is believed that diamine chelating agents can facilitate metal nanoparticle formation by promoting nanoparticle nucleation.

In some embodiments, suitable diamine chelating agents can include N,N′-dialkylethylenediamines, particularly C₁-C₄ N,N′-dialkylethylenediamines. The corresponding methylenediamine, propylenediamine, butylenediamine, pentylenediamine or hexylenediamine derivatives can also be used. The alkyl groups can be the same or different. C₁-C₄ alkyl groups that can be present include, for example, methyl, ethyl, propyl, and butyl groups, or branched alkyl groups such as isopropyl, isobutyl, s-butyl, and t-butyl groups. Illustrative N,N′-dialkylethylenediamines that can be suitable for use in forming metal nanoparticles include, for example, N,N′-di-t-butylethylenediamine, N,N′-diisopropylethylenediamine, and the like.

In some embodiments, suitable diamine chelating agents can include N,N,N′,N′-tetraalkylethylenediamines, particularly C₁-C₄ N,N,N′,N′-tetraalkylethylenediamines. The corresponding methylenediamine, propylenediamine, butylenediamine, pentylenediamine or hexylenediamine derivatives can also be used. The alkyl groups can again be the same or different and include those mentioned above. Illustrative N,N,N′,N′-tetraalkylethylenediamines that can be suitable for use in forming metal nanoparticles include, for example, N,N,N′,N′-tetramethylethylenediamine, N,N,N′,N′-tetraethylethylenediamine, and the like.

Surfactants other than aliphatic amines can also be present in the surfactant system. In this regard, suitable surfactants can include, for example, pyridines, aromatic amines, phosphines, thiols, or any combination thereof. These surfactants can be used in combination with an aliphatic amine, including those described above, or they can be used in a surfactant system in which an aliphatic amine is not present. Further disclosure regarding suitable pyridines, aromatic amines, phosphines, and thiols follows below.

Suitable aromatic amines can have a formula of ArNR¹R², where Ar is a substituted or unsubstituted aryl group and R¹ and R² are the same or different. R¹ and R² can be independently selected from H or an alkyl or aryl group containing from 1 to about 16 carbon atoms. Illustrative aromatic amines that can be suitable for use in forming metal nanoparticles include, for example, aniline, toluidine, anisidine, N,N-dimethylaniline, N,N-diethylaniline, and the like. Other aromatic amines that can be used in conjunction with forming metal nanoparticles can be envisioned by one having ordinary skill in the art.

Suitable pyridines can include both pyridine and its derivatives. Illustrative pyridines that can be suitable for use in forming metal nanoparticles include, for example, pyridine, 2-methylpyridine, 2,6-dimethylpyridine, collidine, pyridazine, and the like. Chelating pyridines such as bipyridyl chelating agents may also be used. Other pyridines that can be used in conjunction with forming metal nanoparticles can be envisioned by one having ordinary skill in the art.

Suitable phosphines can have a formula of PR₃, where R is an alkyl or aryl group containing from 1 to about 16 carbon atoms. The alkyl or aryl groups attached to the phosphorus center can be the same or different. Illustrative phosphines that can be used in forming metal nanoparticles include, for example, trimethylphosphine, triethylphosphine, tributylphophine, tri-t-butylphosphine, trioctylphosphine, triphenylphosphine, and the like. Phosphine oxides can also be used in a like manner. In some embodiments, surfactants that contain two or more phosphine groups configured for forming a chelate ring can also be used. Illustrative chelating phosphines can include 1,2-bisphosphines, 1,3-bisphosphines, and bis-phosphines such as BINAP, for example. Other phosphines that can be used in conjunction with forming metal nanoparticles can be envisioned by one having ordinary skill in the art.

Suitable thiols can have a formula of RSH, where R is an alkyl or aryl group having from about 4 to about 16 carbon atoms. Illustrative thiols that can be used for forming metal nanoparticles include, for example, butanethiol, 2-methyl-2-propanethiol, hexanethiol, octanethiol, benzenethiol, and the like. In some embodiments, surfactants that contain two or more thiol groups configured for forming a chelate ring can also be used. Illustrative chelating thiols can include, for example, 1,2-dithiols (e.g., 1,2-ethanethiol) and 1,3-dithiols (e.g., 1,3-propanethiol). Other thiols that can be used in conjunction with forming metal nanoparticles can be envisioned by one having ordinary skill in the art.

As indicated above, the compositions described herein can also include further additives, such as thermal conductivity enhancers, which can desirably tailor the conformability, workability, adhesiveness, thermal, conductivity and/or electrical conductivity of the composition. Depending on the desired function of the conformable and adhesive solid once deployed, one of ordinary skill in the art will be able to choose a suitable additive to convey a desired function thereto. For example, metal additives can increase both the thermal and electrical conductivity values, whereas diamond particles only serve to increase the thermal conductivity values. In some or other embodiments, the additive can serve to reduce at least the electrical conductivity of the conformable and adhesive solid, which can be desirable in some cases. For example, polymer additives can decrease the electrical conductivity conveyed by the metal nanoparticles used in forming the reaction product or that conveyed by other electrically conductive additives that can be present, such as bulk metal particles. Polymer additives can also alter the mechanical properties and workability of the conformable and adhesive solid in some embodiments. Reasons to include other various additives in the compositions described herein can include, for example, conveyance of EMI shielding, shock protection, vibration protection, impact protection, and acoustical dampening.

In various embodiments, the compositions described herein can further include one or more additives dispersed in the conformable solid. As indicated above, suitable additives can vary widely in structure and function. Suitable additives can include, but are not limited to, bulk metal powders, bulk metal flakes, graphite particles, graphene particles, carbon black particles, amorphous carbon particles, aluminum oxide particles, beryllium oxide particles, magnesium oxide particles, diamond particles, fibrous materials, metal solders, polymers, the like and any combination thereof. Suitable diamond particles can include both diamond particles with ragged edges and cube-like octahedral diamond particles, the latter of which provide better thermal contact surfaces.

When present, an amount of the one or more additives in the compositions can range from above zero to about 90% by weight of the composition. In more specific embodiments, the one or more additives can be present in a range from about 70% to about 90% by weight of the composition, or from about 75% to about 85% by weight of the composition, or from about 77% to about 83% by weight of the composition. In such embodiments, the reaction product and its constituent metal nanoparticles can constitute the balance of the composition.

When one or more thermal conductivity enhancers are present in the ranges noted above, the compositions can display excellent thermal conductivity values. The thermal conductivity values can approach those of bulk metals, or even exceed those of bulk metals, if very thermally conductive additives such as diamond particles are present. In some embodiments, the compositions described herein can have thermal conductivity values of up to about 200 W/m·K or up to about 600 W/m·K. In more particular embodiments, the compositions can have thermal conductivity values ranging between about 100 W/m·K to about 600 W/m·K, or about 100 W/m·K to about 200 W/m·K, or about 200 W/m·K to about 300 W/m·K, or about 300 W/m·K to about 400 W/m·K, or about 400 W/m·K to about 500 W/m·K, or about 500 W/m·K to about 600 W/m·K.

As used herein, the term “bulk metal” will refer to metallic particles that are about 100 nm or larger in size, particularly those that have at least one dimension of about 1 micron or above in size. As used herein, the term “bulk metal flakes” will refer to sheet-like metallic particles that have a thickness smaller than their other dimensions. Suitable bulk metal powders and bulk metal flakes can include, but are not limited to, powders and flakes containing metals such as, for example, copper, silver, gold, aluminum, iron, nickel, zinc, cadmium, molybdenum, tungsten, beryllium, magnesium, calcium, tin and the like. Non-metallic particles can be used similarly, where the term “particle(s)” can refer to both powders and flakes. Suitable non-metallic particles can include, for example, silicon, silicon oxide, graphite, graphite oxide, graphene (single or few-layer), carbon black, amorphous carbon, aluminum oxide, beryllium oxide, magnesium oxide, diamond, and the like.

In some embodiments, suitable metal flakes for use in the compositions described herein can include those having a thickness of about 100 nm to about 2 μm, and a diameter of about 5 μm to about 250 μm.

In some embodiments, suitable bulk metal powders, bulk metal flakes, and/or related non-metallic particles can be present in a variety of size ranges. In some embodiments, at least a portion of the bulk metal powders, the bulk metal flakes, and/or the non-metallic particles can have at least one dimension ranging between about 1 micron and about 44 microns. In some embodiments, at least a portion of the bulk metal powders, the bulk metal flakes, and/or the non-metallic particles can have at least one dimension ranging between about 5 microns and about 250 microns. In some embodiments, at least a portion of the bulk metal powders, the bulk metal flakes, and/or the non-metallic particles can have at least one dimension ranging between about 210 microns and about 890 microns.

In some embodiments, a mixture of two or more sizes of additive particles can be present in the compositions. In some embodiments, two or more sizes of additive particles can be present in a composition in which no flakes are present. In other embodiments, three or more sizes of additive particles can be present in the composition, in which at least one of the additive particles is present in a flake form. Mixtures of different particle size ranges can be used in various embodiments. Use of different particle sizes can maximize packing density and provide a longer mean free path in two dimensions for higher conductivity. In addition, the use of smaller particles in combination with larger particles can result in the smaller particles surrounding the larger particles and increasing contact area. In general, flakes and other non-fibrous structures are believed to promote better thermal conductivity.

Suitable fibrous materials that can be present in the compositions include both bulk fibers and nanofibers. Suitable bulk fibers that can be present include, for example, chopped fibers such as chopped ceramic, carbon or metallic fibers. Ceramic fibers can include, for example, silicon carbide, boron nitride, diamond fibers, and aluminum oxide fibers. In some embodiments, ceramic or carbon fibers can be coated with a metallic coating such as, for example, copper, sliver, gold, palladium, platinum, nickel or cobalt. Such coatings can improve the electrical and thermal conductivity of the fibers and reduce contact impedance. In some embodiments, the coating can range between about 10 nm to about 300 nm in thickness. Suitable nanofibers can include, for example, nanowires, carbon nanotubes (single, double or multi-wall), and the like. Suitable metal fibers can include metal fibers with a diameter of about 200 nm to about 5 microns and a length of about 5 microns to about 50 microns. In some embodiments, fibrous materials can be present in a range up to about 15% by weight of the composition. In more particular embodiments, fibrous materials can be present in the compositions at a range between about 0.01% to about 15% by weight of the composition, with non-fibrous materials making up the balance of the remaining additives.

Metal solders that can be present in the compositions described herein include metals such as, for example, tin, indium, bismuth, gallium, the like and any combination thereof. Tin/lead or lead-free solder alternatives can also be used, many of which will be familiar to one having ordinary skill in the art. Functions of metal solder in the compositions may include lubrication and increasing the contact area between the conductive fibers to improve thermal transfer.

Suitable polymers that can be included as an additive in the compositions described herein are not believed to be particularly limited. In some embodiments, suitable polymers can include, for example, thermosetting polymers such as epoxies, polyurethanes, and polyesters. In other various embodiments, elastomeric polyurethanes can be used. Particular examples of suitable polymers that can be included in the compositions can be envisioned by one having ordinary skill in the art. In various embodiments, those compositions that contain a polymer can have between about 0.01% to about 25% polymer by weight. In more particular embodiments, the compositions can contain about 0.01% to about 3% polymer by weight, or about 1 to about 8% polymer by weight, or about 10% to about 20% polymer by weight.

Including a polymer, particularly an elastomeric polymer, in the compositions can beneficially promote conformance and compliance when applied to a surface, such as a surface in need of thermal management. Conformance and compliance are desirable for thermal interface applications, since intimate contact between a thermal interface material and a surface in need of thermal management (i.e., a heat source and/or a heat sink) usually needs to be maintained to the greatest extent possible in order for efficient heat transfer to take place. In addition, conformance can aid in shock and vibration absorption, such as that encountered during vehicle launch and in automotive and aeronautic operating environments. In this regard, minimized interface resistance may result.

Depending on which additives are present and the amount, the compositions described herein can have a range of densities. For example, when copper powder or flakes are present as the additive, the density can range between about 7.5-8.3 g/cm³. When diamond is used as the additive, the density can range between about 3.0 to 3.8 g/cm³.

Particularly desirable conformable and adhesive compositions of the present disclosure can include the following:
About 77% to about 83% by weight thermally conductive additives, about 15% to about 20% metal nanoparticles by weight, and about 2% to about 5% amines plus carboxylic acids, the metal nanoparticles, the amines and the carboxylic acids being present in the form of a reaction product;
A mixture of thermally conductive particles dispersed in the reaction product, where the thermally conductive additives include at least some large particles in a range from about 50 to about 900 microns in size, at least some metal flakes in a range from about 35 microns to about 250 microns in size and about 100 nm to about 5 microns in thickness, and at least some powder in a range from 500 nm to about 10 microns in size. The mixture of thermally conductive additives is dispersed in a reaction product of the present disclosure at a range between about 75% to about 90% by weight of the composition. In some embodiments, the large particles and the powder are metallic particles and powders. In some embodiments, the large particles, the metal flakes, and the powders can be metallic copper. In some embodiments, the large particles and the powders can be diamond. In some embodiments, the large particles and the powders can be diamond, and the metal flakes can be copper flakes.

In various embodiments, the compositions described herein can constitute a thermal interface material between a heat source and a heat sink. In forming a thermal interface between a heat source and heat sink, the compositions can be spread in a layer and disposed between the heat source and the heat sink. The ultimate compressibility of the layer can be determined by the size of any additives that are present in the compositions. For example, including 2 micron copper particles in the compositions can limit the compositions from being compressed substantially below this thickness in the thermal interface. The compositions can also be rolled into sheets that have a thickness substantially equal to the size of the additive particles therein. A further advantage of the compositions in thermal interface applications is that they undergo only minimal or non-existent creep under an applied load. For example, in an illustrative composition of the present disclosure, no creep was observed over 5 days at a 100 psi load.

In some embodiments, thermal interfaces containing a composition of the present disclosure are described herein. In some embodiments, the thermal interfaces can include a first surface constituting a heat source, a second surface constituting a heat sink, and a thermal interface material in contact with the first surface and the second surface and establishing a thermal connection therebetween. In various embodiments, the thermal interface material can include a conformable and adhesive solid containing a reaction product formed by heating a mixture containing a plurality of metal nanoparticles, optionally one or more organic solvents, one or more amines, and one or more carboxylic acids. In some embodiments, the metal nanoparticles can include at least copper nanoparticles. In some embodiments, one or more additives can be dispersed in the reaction product of the thermal interface material, wherein the one or more additives can include, for example, bulk metal powders, bulk metal flakes, graphite particles, graphene particles, carbon black particles, amorphous carbon particles, aluminum oxide particles, beryllium oxide particles, magnesium oxide particles, diamond particles, fibrous materials, metal solders, polymers, the like and any combination thereof.

In alternative embodiments of the present disclosure, the conformable solids described herein can be prepared with a pre-existing conformable material, such as a polymer (e.g., an elastomer) or other suitable organic binder. In various embodiments, the conformable solids can include a mixture of the organic binder, bulk metal particles and/or bulk metal flakes, and metal nanoparticles. In some embodiments, the metal nanoparticles can include at least copper nanoparticles. Like the compositions described above, such compositions can also be used as a thermal interface material.

Methods for forming the compositions described herein are also contemplated by various embodiments of the present disclosure. In some embodiments, the methods can include providing a mixture containing a plurality of metal nanoparticles, optionally one or more organic solvents, one or more amines, and one or more carboxylic acids; and heating the mixture to form a conformable and adhesive solid as a reaction product.

In some embodiments, heating the mixture to form the reaction product can involve heating the mixture to a temperature up to about 400° C. In other embodiments, heating the mixture to form the reaction product can involve heating the mixture to a temperature up to about 300° C., or heating the mixture to a temperature up to about 200° C. In more particular embodiments, heating the mixture to form the reaction product can involve heating the mixture to a temperature between 100° C. and about 350° C., or between about 150° C. and about 325° C., or between about 200° C. and about 300° C. In some embodiments, the mixture can be heated to a temperature above the fusion temperature of the metal nanoparticles when forming the reaction product. In other embodiments, the mixture can be heated to a temperature below that of the metal nanoparticles when forming the reaction product.

In some embodiments, the methods for forming the conformable and adhesive solid can further include applying the mixture to a surface, where the conformable and adhesive solid is formed while heating the mixture on the surface. Suitable deposition techniques for applying the mixture onto a surface prior to forming the conformable and adhesive solid can include, for example, spray coating, spin coating, ink jet printing, and the like. In some embodiments, the conformable and adhesive solid can be formed on the surface where it is ultimately deployed. For example, in some embodiments, the conformable and adhesive solid can be formed on the surface of a heat source or a heat sink for establishing a thermal interface therebetween. In other embodiments, the methods for forming the conformable and adhesive solid can further include removing the conformable and adhesive solid from the surface after its formation and transferring the conformable and adhesive solid to a secondary substrate. Transferring the conformable and adhesive solid in this manner can take place when the secondary substrate has insufficient thermal or chemical stability to tolerate the conditions used for forming the conformable and adhesive solid from the mixture of metal nanoparticles, amines and carboxylic acids. In some embodiments, an aluminum surface can be used for forming the conformable and adhesive solid during the heating process, since it can readily promote formation of the conformable and adhesive solid while still allowing removal thereof for transfer to a secondary substrate. In some embodiments, the conformable and adhesive solid can be rolled into a sheet either on the surface or following its removal therefrom. Rolling the conformable and adhesive solid into a sheet can allow the conformable and adhesive solid to be shaped as desired, such as for forming a gasket between two surfaces.

The methods for forming the conformable and adhesive solid allow considerable flexibility to be realized in the timing of the addition of further additives. In some embodiments, after heating the mixture to form the conformable and adhesive solid, the methods can include dispersing one or more additives in the conformable and adhesive solid. Various blending techniques for dispersing solid materials in a viscous phase can be used for this purpose, a number of which will be familiar to one having ordinary skill in the art. Addition of further additives at this stage can be used when the reaction conditions would degrade the additives or the additives would inhibit formation of the conformable and adhesive solid, for example. More desirably, in some or other embodiments, the methods for forming the conformable and adhesive solid can farther include combining one or more additives with the mixture before heating to form the conformable and adhesive solid, where the one or more additives become dispersed in the conformable and adhesive solid. Dispersal of the additives in the conformable and adhesive solid as it forms can desirably avoid an extra operation of solids dispersal in a viscous phase. Dispersal of the additives in this manner can take place when the additives are non-reactive under the reaction conditions and do not inhibit formation of the conformable and adhesive solid, for example.

After the conformable and adhesive composition has been formed and the additives have been dispersed therein, it can be compacted under pressure by rolling or using a press, for example. In some embodiments, the conformable and adhesive solid can be reduced in thickness by at least about 50% in such processes, thereby improving the conductivity by increasing contact between the additives. The conformable and adhesive solid does not necessarily become fairy compacted in such compaction processes.

### EXAMPLES

### Example 1

### Process for Making a Conformable and Adhesive Solid from Copper Nanoparticles

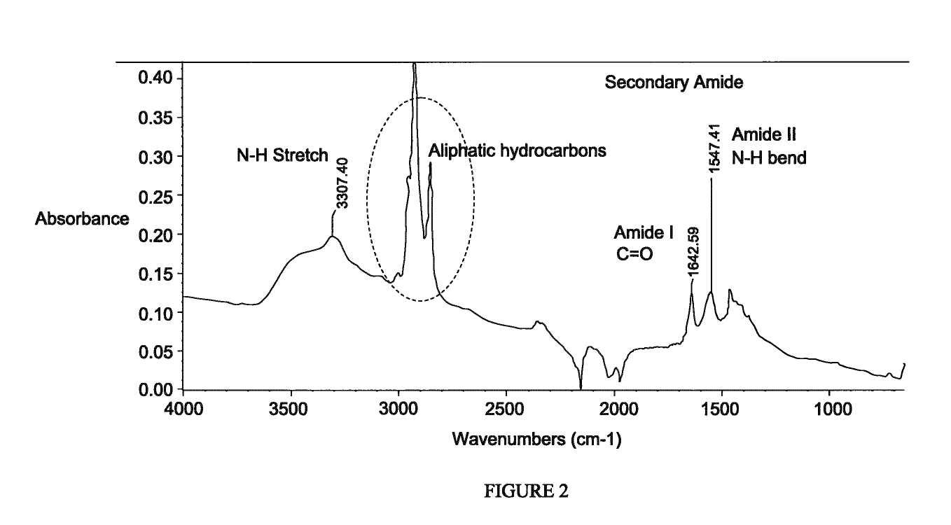

A 1:1 mixture of amines and carboxylic acids (8 g of C16-C18 monoamine and 8 g C16-C18 carboxylic acid) was combined with 63 g of copper nanoparticles, and mixed thoroughly using 7 g of toluene or trimethylbenzene. The reaction mixture was then spread on an aluminum surface, heated over a 13 minute ramp at a ramp rate of 16° C./min to a temperature of 210° C., and held at that temperature for 4 minutes. Cool down was conducted thereafter. Heating was conducted under an inert gas (nitrogen or argon) environment at a gas (low rate of 3 scfm. The thickness of the mixture on the aluminum surface was limited to 1-2 mm to avoid excessive splattering during reaction and solvent removal. The reaction product showed an overall weight loss of about 10% based on the amount of added copper nanoparticles, amines, carboxylic acids, and solvent components. FTIR (FIG. 2) showed the presence of amide groups, indicating the successful coupling of the amines and the carboxylic acids. TGA (FIG. 5) showed that about 12% volatile components remained after forming the reaction product.

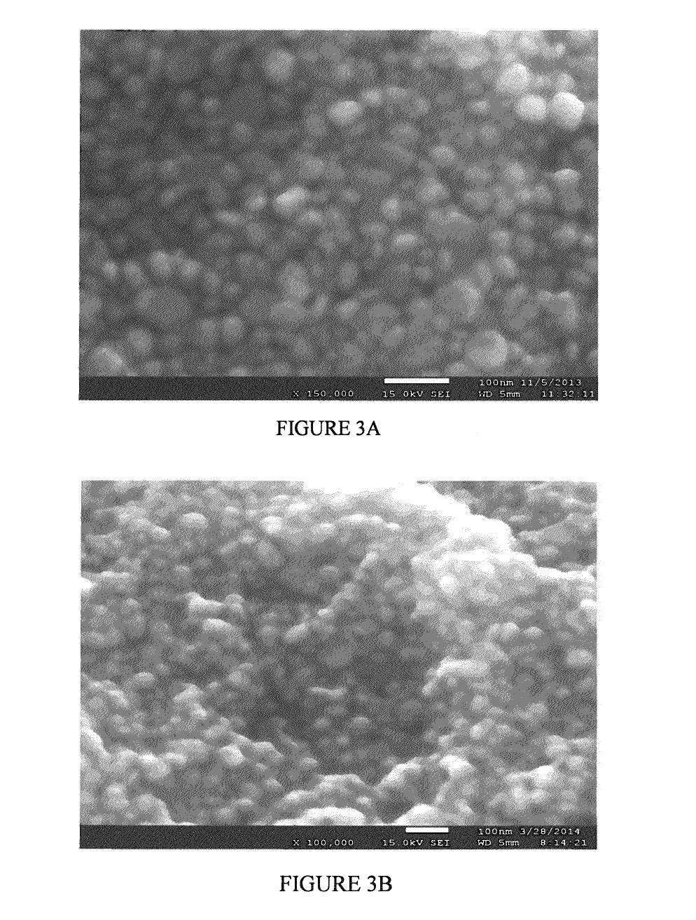

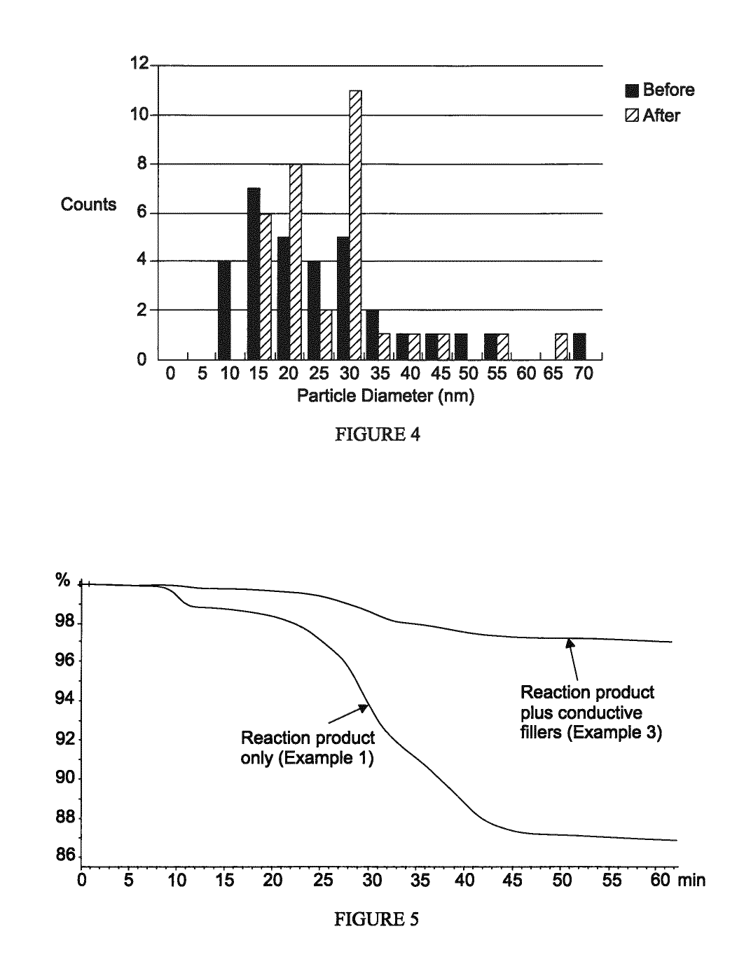

FIGS. 3A and 3B show illustrative comparative SEM images of the copper nanoparticles and the reaction product, respectively. As shown in FIGS. 3A and 3B, the nanoparticulate structure of the copper nanoparticles was largely maintained in the reaction product. FIG. 4 shows an illustrative plot of the copper nanoparticle size distribution before and after forming the reaction product. As shown in FIG. 4, some of the smaller copper nanoparticles disappeared upon forming the reaction product, and the proportion of larger copper nanoparticles increased.

### Example 2

### Process for Making a Conformable and Adhesive Solid from Copper Nanoparticles

A 1:1 mixture of amines and carboxylic acids (6 g of C16-C18 monoamine and 6 g C16-C18 carboxylic acid) was combined with 63 g of copper nanoparticles and mixed thoroughly without using a solvent. The reaction mixture was then spread on an aluminum surface, heated over a 13 minute ramp at a ramp rate of 16° C./min to a temperature of 210° C., and held at that temperature for 4 minutes. Cool down was conducted thereafter. Heating was conducted under an inert gas (nitrogen or argon) environment at a gas flow rate of 3 scfm. The thickness of the mixture on the aluminum surface was limited to 1-2 mm to avoid excessive splattering during reaction and solvent removal. Similar properties compared to those of Example 1 were observed in the reaction product, except the overall weight loss on forming the reaction product was only about 4% based on the added copper nanoparticles, amines, and carboxylic acids.

### Example 3

### Process for Making a Conformable and Adhesive Solid also Containing a Thermally Conductive Additive

A 1:1 mixture of amines and carboxylic acids (1.2 g of C16-C18 monoamines and 1.2 g C16-C18 carboxylic acids) was combined with 12.6 g copper nanoparticles, 43.2 g of 50-70 mesh copper powder, 5 g of 44 micron copper flakes and 2.5 g of 325 mesh copper powder. 5 mL of isopropanol was also added to improve dispersibility. The mixture was then centrifuged, and excess solvent was removed. The reaction mixture was then spread on an aluminum surface, heated over a 13 minute ramp at a ramp rate of 16° C./min to a temperature of 210° C., and held at that temperature for 4 minutes. Cool down was conducted thereafter. Heating was conducted under an inert gas (nitrogen or argon) environment at a gas flow rate of 4 scfm. The thickness of the mixture on the aluminum surface was limited to 2-3 mm to avoid excessive splattering during reaction and solvent removal. The reaction product showed no creep over 5 days at a 100 psi load under a vacuum of 5-10 torr and a viscosity of >2500 Poise. FIG. 5 shows an illustrative TGA plot comparing the composition of Example 1 with the composition of Example 3. The decreased weight loss percentage is believed to be due to the high weight percentage of the copper additives. The material was compacted and rolled out using a standard industrial double-roller system, resulting in a reduction in thickness of at least 50% to form a gasket-type material with a thin, blanket-type structure.

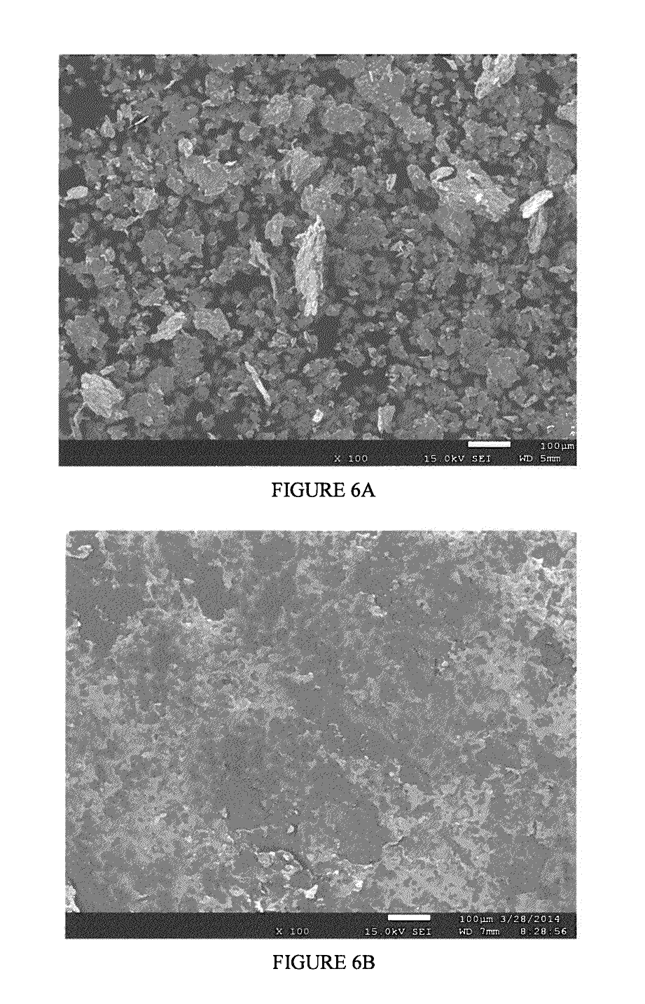

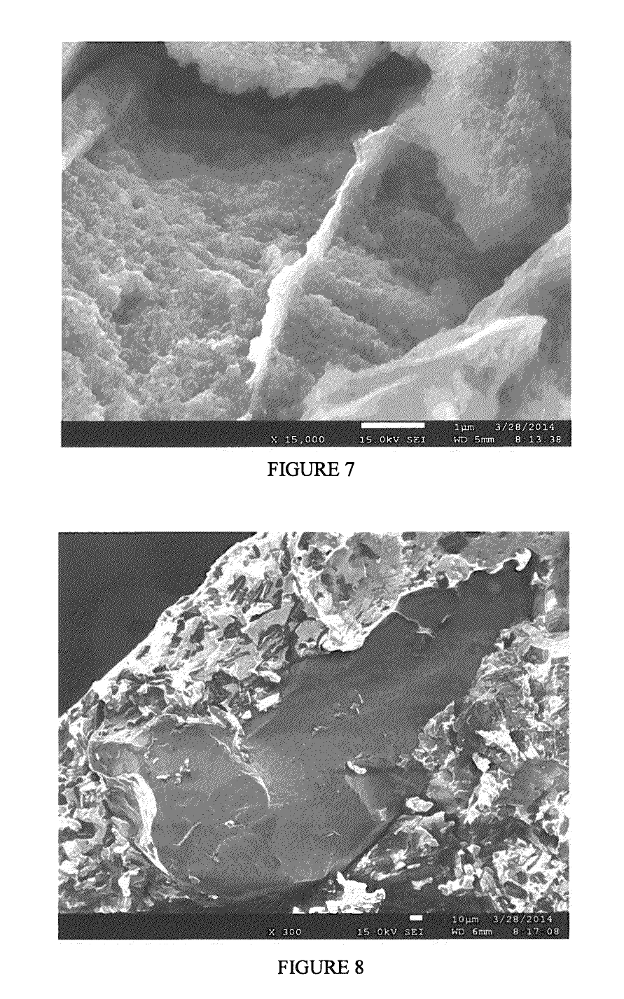

FIGS. 6A and 6B show illustrative SEM images of the reaction product of Example 3 before and after compacting, respectively. As shown in the SEM images, the reaction product formed a continuous phase in which larger additive materials were well dispersed. FIGS. 7 and 8 show increased magnification SEM images of the reaction product of Example 3. As shown in FIGS. 7 and 8, the additives were largely embedded in the continuous matrix formed by the reaction product.

Although the disclosure has been described with reference to the above embodiments, one of ordinary skill in the art will readily appreciate that these only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description.

What is claimed is the following:

1. A composition comprising:
a conformable and adhesive solid comprising a reaction product formed by heating a mixture comprising:
a plurality of metal nanoparticles,
one or more amines, and
one or more carboxylic acids.

2. The composition of claim 1, wherein the metal nanoparticles comprise at least copper nanoparticles.

3. The composition of claim 1, wherein the mixture from which the reaction product is formed further comprises one or more organic solvents and comprises, in total, between about 10% to about 28% by weight of organic solvents, amines plus carboxylic acids.

4. The composition of claim 3, wherein the metal nanoparticles comprise the balance of the mixture.

5. The composition of claim 1, wherein the metal nanoparticles range between about 1 nm and about 50 nm in size and include a surfactant coating thereon.

6. The composition of claim 1, further comprising:
one or mom additives dispersed in the conformable and adhesive solid.

7. The composition of claim 6, wherein the one or more additives are selected from the group consisting of bulk metal powders, bulk metal flakes, graphite particles, graphene particles, carbon black particles, amorphous carbon particles, aluminum oxide particles, beryllium oxide particles, magnesium oxide particles, diamond particles, a fibrous material, a metal solder, a polymer, and any combination thereof.

8. The composition of claim 6, wherein an amount of the one or more additives dispersed in the conformable and adhesive solid ranges from above zero to about 90% by weight of the composition.

9. The composition of claim 8, wherein the conformable and adhesive solid comprises the balance of the composition.

10. A method comprising:
providing a mixture comprising:
a plurality of metal nanoparticles,
one or more amines, and
one or more carboxylic acids; and
heating the mixture to form a conformable and adhesive solid as a reaction product.

11. The method of claim 10, wherein the metal nanoparticles comprise at least copper nanoparticles.

12. The method of claim 10, wherein the metal nanoparticles range between about 1 nm and about 50 nm in size and include a surfactant coating thereon.

13. The method of claim 10, further comprising:
applying the mixture to a surface;
wherein the conformable and adhesive solid is formed white heating the mixture on the surface.

14. The method of claim 13, further comprising:
removing the conformable and adhesive solid from the surface and transferring the conformable and adhesive solid to a secondary substrate.

15. The method of claim 10, further comprising:
combining one or more additives with the mixture before heating to form the conformable and adhesive solid, the one or more additives becoming dispersed in the conformable and adhesive solid.

16. The method of claim 15, wherein the one or more additives are selected from the group consisting of bulk metal powders, bulk metal flakes, graphite particles, graphene particles, carbon black particles, amorphous carbon particles, aluminum oxide particles, beryllium oxide particles, magnesium oxide particles, diamond particles, a fibrous material, a metal solder, a polymer, and any combination thereof.

17. The method of claim 10, further comprising:
after heating the mixture to form the conformable and adhesive solid, dispersing one or more additives in the conformable and adhesive solid.

18. The method of claim 17, wherein the one or more additives are selected from the group consisting of bulk metal powders, bulk metal flakes, graphite particles, graphene particles, carbon blank particles, amorphous carbon particles, aluminum oxide particles, beryllium, oxide particles, magnesium oxide particles, diamond particles, a fibrous material, a metal solder, a polymer, and any combination thereof.

19. The method of claim 10, wherein the mixture from which the reaction product is formed further comprises one or more organic solvents and comprises, in total, between about 10% to about 28% by weight of organic solvents, amines plus carboxylic acids, and the metal nanoparticles comprise the balance of the mixture;
wherein at least a portion of the one or more organic solvents evaporates while heating the mixture to form the conformable and adhesive solid.

20. A thermal interface comprising:
a first surface comprising a heat source;
a second surface comprising a heat sink; and
a thermal interface material in contact with the first surface and the second surface and establishing a thermal connection therebetween;
wherein the thermal interface material comprises:
a conformable and adhesive solid comprising a reaction product formed by heating a mixture comprising:
a plurality of metal nanoparticles, the metal nanoparticles comprising at least copper nanoparticles,
one or more amines, and
one or more carboxylic acids; and
one or more additives dispersed in the conformable and adhesive solid, the one or more additives being selected from the group consisting of bulk metal powders, bulk metal flakes, graphite particles, graphene particles, carbon black particles, amorphous carbon particles, aluminum oxide particles, beryllium oxide particles, magnesium oxide particles, diamond particles, a fibrous material, a metal solder, a polymer, and any combination thereof.
